(19) United States
(12) Patent Application Publication
(10) Pub. No.: US 2012/0006173 A1
(43) Pub. Date: Jan. 12, 2012

(54) SHEET PUNCHING DEVICE, SHEET FINISHER HAVING THE SHEET PUNCHING DEVICE AND IMAGE FORMING SYSTEM EQUIPPED THEREWITH

(75) Inventor: Tomohiko KIRYU, Tokyo (JP)

(73) Assignee: KONICA MINOLTA BUSINESS TECHNOLOGIES, INC., Tokyo (JP)

(21) Appl. No.: 13/173,335

(22) Filed: Jun. 30, 2011

(30) Foreign Application Priority Data
Jul. 7, 2010 (JP) JP2010-154621

(51) Int. Cl. B26D 5/16; B26F 1/00

(52) U.S. Cl. 83/620; 83/628

(57) ABSTRACT

A punching device includes: plural punches and a die having plural punching holes with each of which each punch is engaged and arranged to be spaced apart; a support member which supports rotatably each punch and movably in a direction of each rotation axis, on which a fixed cam member including a first cam hole having a first vertical and inclined portions, is provided; and a movable cam member including a second cam hole having a second inclined portion, provided on the fixed cam member, movable in an orthogonal direction; wherein each punch has a pin passing through each of the first and second cam holes, and when each pin is regulated by the first vertical and second inclined portions, each punch moves toward the die, and when each pin is regulated by the first and the second inclined portions, each punch moves toward the die and rotates about each axis.

This application is based on Japanese Patent Application No. 2010-154621 filed on Jul. 7, 2010, which is incorporated hereinto by reference.

### BACKGROUND OF THE INVENTION

The present invention relates to a punching device, a sheet finisher equipped with the punching device and an image forming system equipped with the sheet finisher.

There is known a punching device having therein a punch, a die and a cam plate that has thereon a cam hole and is movable in the horizontal direction, wherein a pin that urges the punch in the direction of an axis through the cam hole is fixed on the punch and it causes the punch to go down through the cam hole when the movable cam moves, to bore a punched hole (see, for example, Japanese Patent Application Publication No. 2000-9791).

The punching device described in Japanese Patent Application Publication No. 2000-9791, however, has caused a problem that a load during punching is heavy and a shocking noise was caused when sheet punching is finished, because a load applied on the device during punching is great, and it decreases suddenly when punching is completed, although the structure is simple.

Further, under the influence of efficient business, there are increased demands from customers for introduction of an image forming system wherein an image forming apparatus is connected to the sheet finisher capable of punching holes. The image forming system of this kind is arranged in an office frequently, causing a problem that an office environment is worsened by the aforesaid shocking noise generated by the punching device in quiet office.

As a means of settling this problem of a noise, there is known the punching device that punches a punched hole on a sheet by scanning a punch to go down while it is rotating (for example, see Japanese Patent Application Publication No. 2009-142911).

The punching device described in Japanese Patent Application Publication No. 2000-9791 has had a problem of a noise.

The punching device described in Japanese Patent Application Publication No. 2009-142911 has an advantage that a punch does not generate the aforesaid noise when the punch is rotated. However, in its mechanism, a pinion is provided on a punch to be a rotating mechanism for the punch, a cylindrical rotary cam having a chevron-shaped cam groove is provided on the punch to be an up-and-down mechanism for the punch, and the punch is rotated by the pinion by rotating the pinion with a rack gear that engages with the aforesaid pinion, thus, the punch is rotated by the pinion to cause the punch to move up-and-down by urging the chevron-shaped cam groove by a pin fixed on the outside that urges the aforesaid cam groove.

In this way, the structure in the peripheral of the punch, in particular, turns out to be complicated because the rotating mechanism for the punch and the up-and-down mechanism are needed. In addition, the punch has been rotated also during the period other than the sheet boring period. Thus, a portion of the inclined part of the chevron-shaped cam groove which contributed to punching of the sheet has been small.

Because of the complicated structure in the periphery of the punch, there have been a problem that a replacement job for a punch caused by abrasion of a cutting edge is complicated, a problem that of possibility to lower productivity caused by repairing, and there is a possibility that only a part of inclined portion can contribute for punching and an amount of punch rotation is small and stable punching is not possible.

### SUMMARY OF THE INVENTION

An aspect of the invention is as follows.

1. In the first punching unit, a punching device includes: a plurality of punches each of which is arranged to be spaced apart from each other by a predetermined distance; a die including a plurality of punching holes with each of which each of the plurality of punches is engaged; a support member which supports rotatably each of the punches and movably in a direction of each rotation axis thereat a fixed cam member provided on the support member, on which a first cam hole is formed in a position corresponding to each of the punches, the first cam hole having at least a first vertical portion that extends in a direction parallel to each rotation axis of the punches and a first inclined portion that connects with the first vertical portion at a predetermined angle to each rotation axis of the punches and extends toward the die; and a movable cam member provided on the fixed cam member, capable of moving along the support member in a direction perpendicular to each rotation axis of the punches, on which a second cam hole is formed in the position corresponding to each of the punches to be spaced apart from each other by the predetermined distance, the second cam hole having at least a second inclined portion which has a predetermined angle to each rotation axis of the punches and turns toward a side opposite to the first inclined portion; wherein each of the plurality of punches has a pin passing through each of the first and second cam holes, and wherein when the pin is regulated by the first vertical portion and the second inclined portion, each of the punches moves toward the die by movement of the movable cam member, and when the pin is regulated by the first inclined portion and the second inclined portion, each of the punches moves toward the die by the movement of the movable cam member and rotates about each rotation axis of the punches.

2. In the punching device described in above Item 1, an end portion of the first vertical portion and an end portion of the second inclined portion on an opposite side of the die in a direction parallel to each rotation axis of the punches, are in the same position as each other, and an end portion of the first inclined portion and an end portion of the second inclined portion on a side of the die in the direction parallel to each rotation axis of the punches, are in another same position as each other.

3. In the punching device described in above Item 1 or 2, the following expression is satisfied,

L11=L2+d2+d3

where L11 represents a distance in the direction in parallel to each axis of the punches between a point at an intersection of a center line of the first vertical portion with a center line of the first inclined portion, and an upper surface of the die with which the punch is engaged; L2 represents a distance between a center of an axis of each of the pins and a cutting edge of each of the punches; d2 represents a maximum thickness of a sheet to be used; and d3 represents room which is a gap between the cutting edge of each of the punches and an upper surface of the sheet having the maximum thickness, when the center of the axis of the pin is positioned at the point at the intersection.

4. In the second punching unit, a punching device includes: a plurality of punches each of which is arranged to be spaced apart from each other by a predetermined distance; a die including a plurality of punching holes with each of which each of the plurality of punches is engaged; a support member which supports rotatably each of the punches and movably in a direction of each rotation axis thereof, a fixed cam member provided on the support member, on which a first cam hole is formed in a position corresponding to each of the punches, the first earn hole having a first vertical portion that extends in a direction parallel to each rotation axis of the punches, a first inclined portion that connects with the first vertical portion at a predetermined angle to each rotation axis of the punches and extends toward the die, and a second vertical portion that connects with the first inclined portion and extends in the direction parallel to each rotation axis of the punches toward the die; and a movable cam member provided on the fixed cam member, capable of being moved along the support member in a direction perpendicular to each rotation axis of the punches, on which a second cam hole is formed in the position corresponding to each of the punches to be spaced apart from each other by a predetermined distance, the second cam hole having a first horizontal portion that extends in the direction perpendicular to each rotation axis, a second inclined portion having a predetermined angle to each rotation axis of the punches that connects with the first horizontal portion, extends toward the die, and turns toward a side opposite to the first inclined portion, and a second horizontal portion that connects with the second inclined portion and extends in the direction perpendicular to each rotation axis of the punches;

wherein each of the plurality of punches has a pin passing through each of the first and second cam holes, and

wherein when the pin is regulated by the first horizontal portion and the first vertical portion, or is regulated by the second horizontal portion and the second vertical portion, each of the punches stops, when the pin is regulated by the first vertical portion and the second inclined portion, the punch moves toward the die by movement of the movable cam member, and when the pin is regulated by the first inclined portion and the second inclined portion, the punch moves toward the die by the movement of the movable cam member and rotates about each rotation axis of the punches.

5. In the punching device described in above Item 4, an end portion of the first vertical portion and an end portion of the first horizontal portion on an opposite side of the die in a direction parallel to each axis of the punches, have the same position as each other, and an end portion of the second vertical portion and an end portion of the second horizontal portion on a side of the die in the direction parallel to each axis of the punches, in the same position as each other.

6. In the punching device described in above Item 4 or 5, the following expression is satisfied,

L12=L2+d2+d3

where L12 represents a distance in a direction in parallel to each axis of the punches between a point at an intersection of a center line of the first vertical portion with a center line of the first inclined portion, and an upper surface of the die with which the punch is engaged; L2 represents a distance between a center of an axis of each of the pins and a cutting edge of each of punches; d2 represents a maximum thickness of a sheet to be used; and d3 represents room which is a gap between the cutting edge of the punch and an upper surface of the sheet having the maximum thickness, when the center of the axis of the pin is positioned at the point at the intersection.

7. In third and fourth punching units, a punching device includes: four punches; a die including four punching holes with each of which each of the four punches is engaged; a support member which supports rotatably each of the punches and movably in a direction of each rotation axis direction thereof to be spaced apart from each other by a predetermined distance; a fixed earn member at which the support member is provided, on which a first cam hole is formed at both end portions thereof at a position corresponding to each of two outermost punches of the four punches, the first cam hole having a first vertical portion that extends in a direction parallel to each rotation axis of the punches and a first inclined portion that connects with the first vertical portion at a predetermined angle to each rotation axis of the punches and extends toward the die, and a second vertical portion that connects with the first inclined portion and extends in a direction parallel to each rotation axis of the punches toward the die, and on which a second cam hole is formed at a central portion thereof at a position corresponding to each of two innermost punches of the four punches, having a third vertical portion that extends in a direction parallel to each rotation axis of the punches; and a movable cam member provided on the fixed cam member, capable of moving along the support member in a direction perpendicular to each rotation axis, on which a third cam hole is formed at both end portions thereof at a position corresponding to each of two outermost punches of the four punches to be spaced apart from each other by a predetermined distance, the third cam hole having a first horizontal portion that extends in a direction perpendicular to each rotation axis of the punches, a second inclined portion that connects with the first horizontal portion at a predetermined angle to each rotation axis of the punches and turns toward a side opposite to the first inclined portion, and a second horizontal portion that connects with the second inclined portion and extends in a direction perpendicular to each rotation axis of the punches toward the die, and on which a fourth cam hole is formed at a central portion thereof at a position corresponding to each of two innermost punches of the four punches to be spaced apart from each other by a predetermined distance, the fourth cam hole having a third horizontal portion that extends in the direction perpendicular to each rotation axis of the punches, a third inclined portion that connects with the third horizontal portion at a predetermined angle to each rotation axis of the punches and turns toward a side opposite to the second inclined portion, a fourth horizontal portion that connects with the third inclined portion and extends in the direction perpendicular to each rotation axis of the punches, a fourth inclined portion that connects with the fourth horizontal portion at a predetermined angle to each rotation axis of the punches and turns toward a side opposite to the third inclined portion, and a fifth horizontal portion that connects with the fourth inclined portion on the side of the die and extends in the direction perpendicular to each rotation axis of the punches,

wherein each of the two outermost punches of the four punches has a pin which passes through the first and third cam holes, and each of the two innermost punches has a pin which passes through the second and fourth holes,

wherein when each of the two innermost pins is regulated by one of the fourth horizontal portion, the third horizontal portion or the fifth horizontal portion, and by the third vertical portion, each of the two innermost pins stops, thereby each of the two innermost punches stops,

wherein when each of the two outermost pins is regulated by first horizontal portion and the first vertical portion, or by the second horizontal portion and the second vertical portion, each of the two innermost pins stops, thereby each of the two innermost punches stops,

wherein when each of the two innermost pins is regulated by one of the third or fourth inclined portion and the third vertical portion, each of the two innermost punches moves toward the die by movement of the movable cam member,

wherein each of the two outermost pins is regulated by the first vertical portion and the second inclined portion, each of the two outermost punches moves toward the die by the movement of the movable cam member, and

wherein each of the outermost pins is regulated by the first and the second inclined portions, each of the two outermost punches moves toward the die while being rotated by the movement of the movable cam member.

8. In the punching device described in above Item 7, an end portion of the third vertical portion and an end portion of the first vertical portion on an opposite side of the die in the direction parallel to each axis of the punches, the fourth horizontal portion and the first horizontal portion, have the same position as each other, and an end portion of the third vertical portion on the side of each of the die and an end portion of each of the third, fifth and second horizontal portions in the direction parallel to each axis of the punches, have another same position as each other.

9. In the punching device described in above Item 7 or 8, an entire length in a horizontal direction of the third cam hole is equal to that of an entire length in the horizontal direction of the fourth cam hole.

10. In the punching device described in any one of above Items 7-9, when two holes are punched, the movable member moves toward one direction from a standby state at which each of the two innermost pins is positioned in a central portion of the entire length of the third cam hole in the horizontal direction, and each of the two outermost pins is positioned in a central portion of the entire length of the fourth cam hole in the horizontal direction, thereby the two innermost punches only are operated, and when four holes are punched, the movable member moves toward another direction from a standby state at which each of the two innermost pins is positioned in the central portion of the entire length of the third cam hole in the horizontal direction, and each of the two outermost pins is positioned in the central portion of the entire length of the fourth cam hole in the horizontal direction, thereby the two innermost punches and the two outermost punches are operated.

11. In the punching device described in above Item 7 or 8, the following expression is satisfied,

L13=L2+d2+d3

where L13 represents a distance in a direction in parallel to each axis of the punches between a point at an intersection of a center line of the first vertical portion with a center line of the first inclined portion, and an upper surface of the die with which the punch is engaged; L2 represents a distance between a center of an axis of each of the pins of the two outermost punches and a cutting edge of each of the two outermost punches; d2 represents a maximum thickness of a sheet to be used; and d3 represents room which is a gap between the cutting edge of the punch and an upper surface of a sheet having the maximum thickness, when the center of the axis of each of the pins of the punches is positioned at the point at the intersection.

12. The punching device described in any one of above Items 1-11, further includes a moving section which is capable of moving the movable cam member in the direction perpendicular to each axis of the punches.

13. In the punching device described in any one of above Items 1-12, a cutting end of each of the punches has a recess, and a protruded portion of the cutting end forms the cutting edge.

14. In the punching device described in any one of above Items 1-13, the movable cam member has a tabular form.

15. A sheet finisher includes the punching device described in any one of above Items 1-14.

16. An image forming system includes: an image forming apparatus that forms an image on a recording sheet; and the sheet finisher described in above Item 15 conducts a post processing on the recording sheet that has been formed by the image forming apparatus.

### BRIEF DESCRIPTION OF THE DRAWINGS

FIG. 1 is a diagram of an image forming system having therein an image forming apparatus and a sheet finisher.

FIG. 2 is a diagram showing an example of the image forming apparatus.

FIG. 3 is a diagram of the sheet finisher having a punching device.

Each of FIGS. 4A-4B is a diagram of a punching unit in the first embodiment.

Each of FIGS. 5A-5B is a diagram of a punching unit in the second embodiment.

Each of FIGS. 6A-6D is a diagram of operations of the unit in the second embodiment.

Each of FIGS. 7A-7B is a detailed diagram concerning a punch and a cam hole.

FIG. 8 is a diagram of a punching device that punches two holes.

FIG. 9 is a diagram of a punching device that punches four punched holes.

FIG. 10 is a diagram of a cam hole relating to the third punching unit 3.

FIG. 11 is a diagram of a cam hole relating to the fourth punching unit 4.

### DETAILED DESCRIPTION OF THE PREFERRED EMBODIMENT

Wording will be explained before explaining each structure. In the following explanations, the vertical direction means directions which are parallel with an axis of the punch, and a direction toward the upper part among the vertical directions is a direction for the punch to recede from the die, and a direction toward the lower part is a direction for the punch to approach the die.

Further, a horizontal direction means a direction perpendicular to the axis of the punch, and one of horizontal directions is left, and the other is called the right.

Further, the upstream side means a direction from which a sheet is conveyed, and the downstream side means a direction toward which a sheet is conveyed.

Further, a standby position for the punch means a position for taking shelter that represents a reference for the punch before entering the operations in the punching processing.

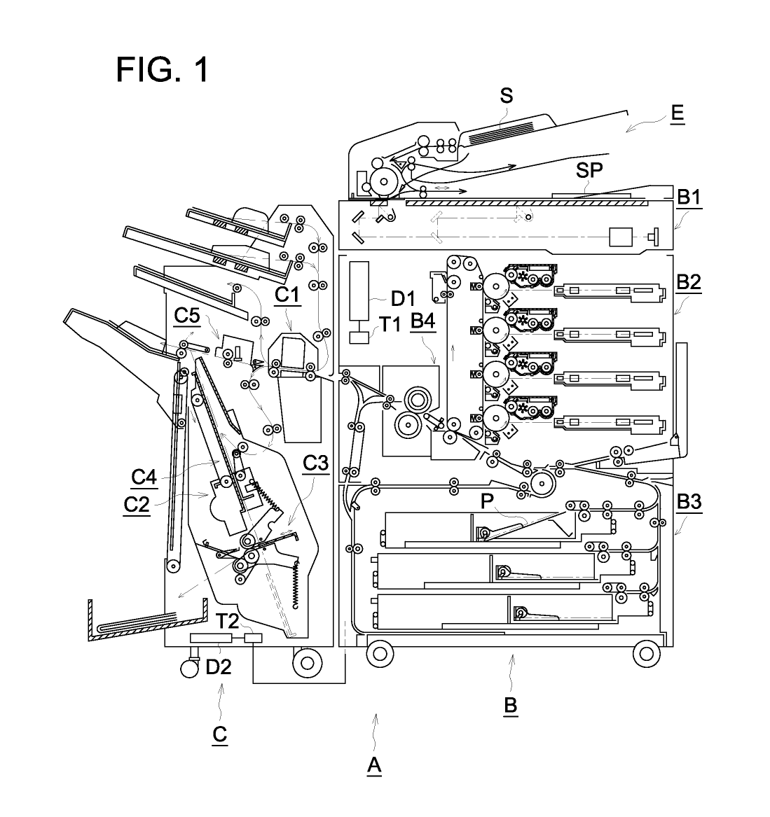

FIG. 1 is a diagram of an image forming system having an image forming apparatus and a sheet finisher.

Image forming system A has therein image forming apparatus B and sheet finisher C, and image forming is carried out on sheet P in image forming apparatus B, while, in the sheet finisher C, the post processing jobs established by the image forming apparatus 13 including the punching to bore a hole on sheet P are carried out.

The image forming apparatus B of an electrophotographic system has therein document image reading section B1 that reads document images, image forming section B2 that conducts image forming based on document image information obtained by the document image reading section B1, sheet feeding section B3 that supplies sheet P to image forming section B2, fixing section B4 that fixes a toner image, operation panel SP having a display device and operation switches and main controller D1 that controls above items.

Then, automatic document conveyance device E is installed on the upper part of image forming apparatus B, and document S is conveyed toward document image reading section.

Sheet finisher C needs to have a punching section that bores a punched hole on a sheet, and it has, for example, punching device C1 representing a punching section that conducts punching on sheet P, stapling section C2 that staples a bundle of sheets, folding section C3 that folds a bundle of sheets, stacker C4 on which sheets are stacked temporarily, shifting section C5 that shifts laterally and post-processing controller D2 that controls the aforesaid items.

Further, the image forming apparatus B has another device such as, for example, communication device T1 that communicates with the sheet finisher C, and the sheet finisher C has another device such as, for example, communication device T2 that communicates with the image forming apparatus B.

Each of main control section D1 of the image forming apparatus B and post-processing control section D2 of the sheet finisher C conducts respectively delivery and receipt of various pieces of information through each of communication device T1 and communication device T2.

Information (punching processing, for example) relating to post-processing established on operation panel SP of the image forming apparatus B is transmitted to the communication device T1 of the sheet finisher C through the communication device T2, and the sheet finisher C conducts post-processing (punching processing, for example) based on information relating to the transmitted post-processing.

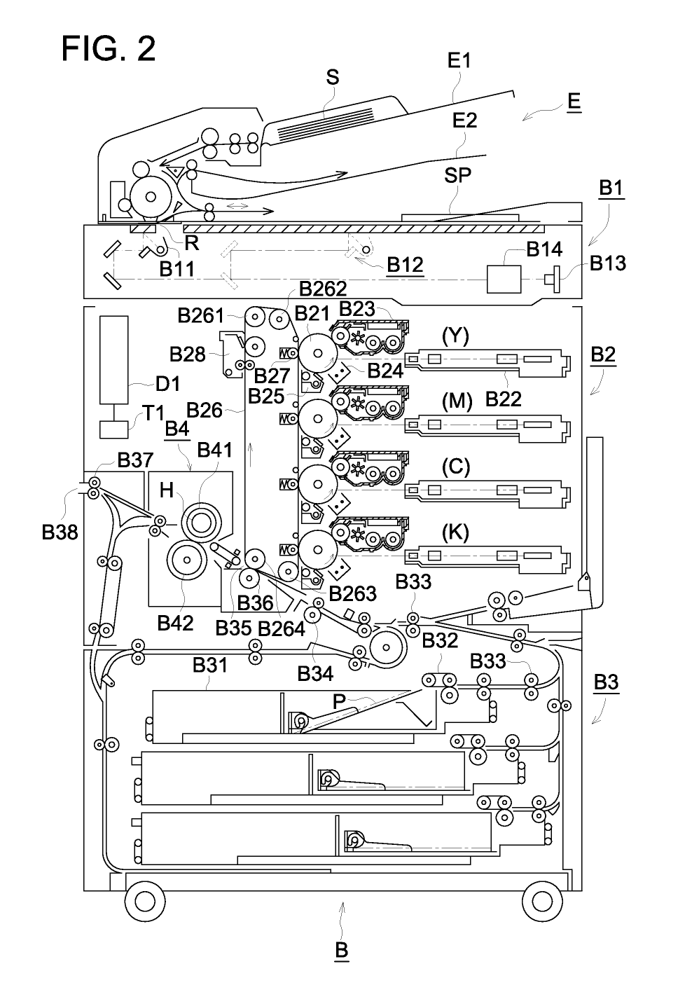

FIG. 2 is a diagram showing an example of an image forming apparatus.

As an example of the image forming apparatus B, an image forming apparatus that is called a full-color copying machine of a tandem type will be explained as follows.

Automatic document feeder E feeds document S stacked on sheet feeding tray E1 one sheet by one sheet to document reading area R by plural couples of rollers, and the document S that has been read in document reading area R is ejected to sheet ejection tray E2.

Document image reading section B1 has therein light source B11, scanning unit B12 capable of moving along document S placed on the document image reading section B1 and optical system B14 that forms document images on line image sensor B13, and for example, in the case of reading operations by static optical system, for example, images of document S conveyed by automatic document conveying device D are read in the document reading area R, by fixing the scanning unit B12.

Analog signals of the document images converted photo-electrically by line image sensor B13 are subjected to analog processing, A/D conversion, shading correction and image compression in an unillustrated image processing section, to become digital image data for Y (yellow), M (magenta), C (cyan) and K (black) colors.

Image forming section B2 has therein drum-shaped photoconductor B21 (21Y, 21M, 21C and 21K) representing the first image carrier for respective colors of Y, M, C and K, exposure section B22 (22Y, 22M, 22C and 22K) that forms a latent image based on digital image data for each color on a surface of photoconductor 21, developing section 23 (23Y, 23M, 23C and 23K) that develops the latent image corresponding to each color, charging section 24 (24Y, 24M, 24C and 24K) that charges the image forming section 21 uniformly and cleaning section B25 (25Y, 25M, 25C and 25K) that removes toner that remains without being transferred.

A latent image based on digital image data for each color is formed in exposure section B22, and the latent image is developed by the developing section B23 as a toner image.

Semiconductive endless belt shaped intermediate transfer body B26 is trained about rollers B261, B262, B263 and B264 is arranged to face each of photoconductors B21 (21Y, 21M, 21C and 21K), and the intermediate transfer body B26 is driven in the direction of an arrow through roller B263 by an unillustrated driving device.

A toner image for each color carried by each photoconductor B21 is transferred onto intermediate transfer body B26 successively through compression of primary transfer roller B27 (27Y, 27M, 27C and 27K), and a composite color image is formed on intermediate transfer body B26.

The sheet feeding section B3 has a plurality of sheet-feeding cassette B31, and sheet P is housed in the sheet-feeding cassette B31.

Sheets P housed in the cassette are picked up one sheet by one sheet by sheet-feeding roller B32 to be conveyed to transfer area B35 through plural conveyance rollers B33 and registration roller B34, thus, the composite toner images on the intermediate transfer body are transferred onto sheet P collectively by secondary transfer roller B36.

Incidentally, toner remaining on the intermediate transfer body B26 without being transferred is removed by cleaning section 28.

The sheet onto which the color image has been transferred is separated from the intermediate transfer body B26 through a curvature effect by roller B264, and is fixed by fixing section B4 having heat roller B41 housing therein heat source H and pressure roller B42.

Then, the sheet on which the toner image has been fixed is interposed by sheet ejection roller B37 to be supplied to the sheet finisher C from outlet 838 in the downstream side.

Operation panel SP has a touch panel and various types of operation switches, and main control section Dl causes a touch panel of operation panel SP to indicate information relating to post-processing and it causes communication device T2 of sheet finisher C to transmit through communication device T1.

As information relating to post-processing, there are given information relating to, for example, punching processing such as information of presence or absence of punching, 2-hole processing information and 4-hole processing information.

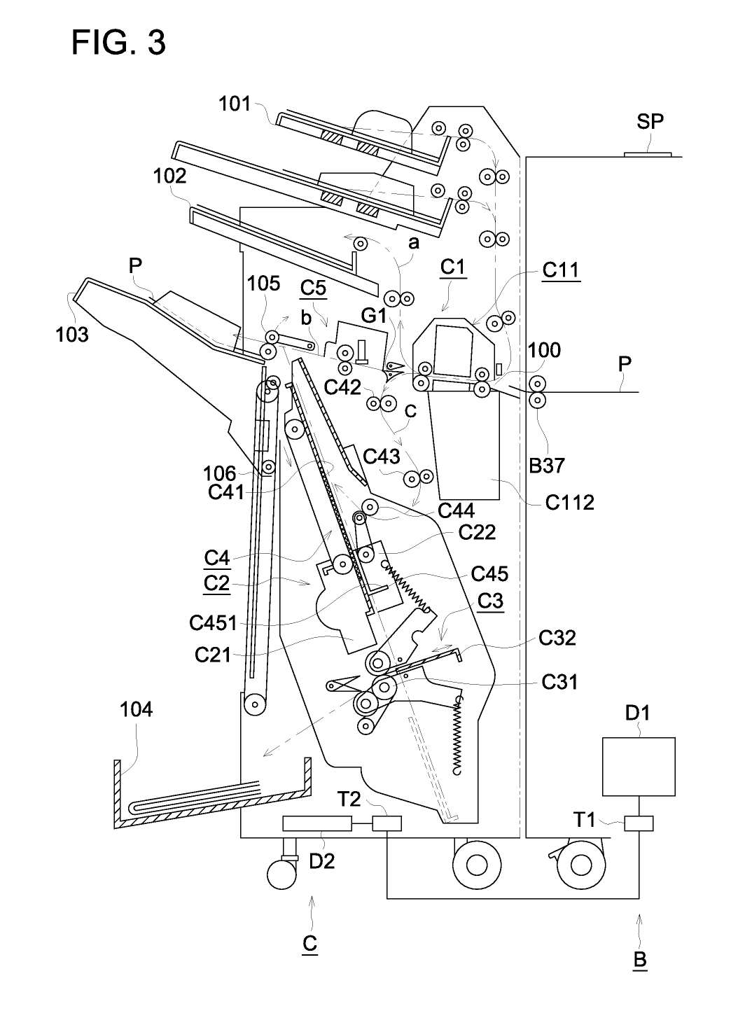

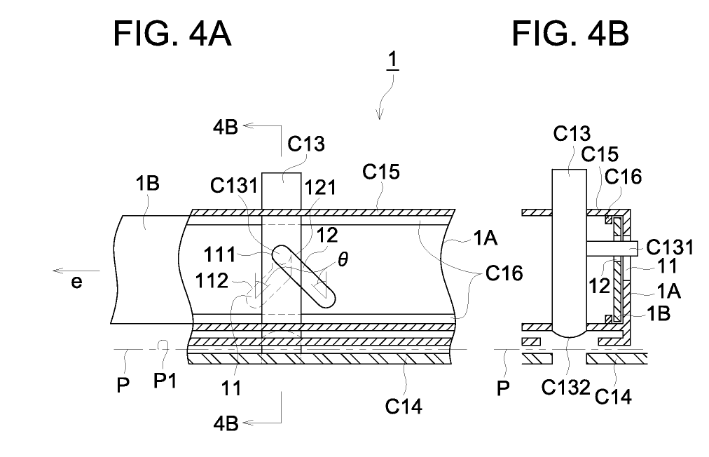

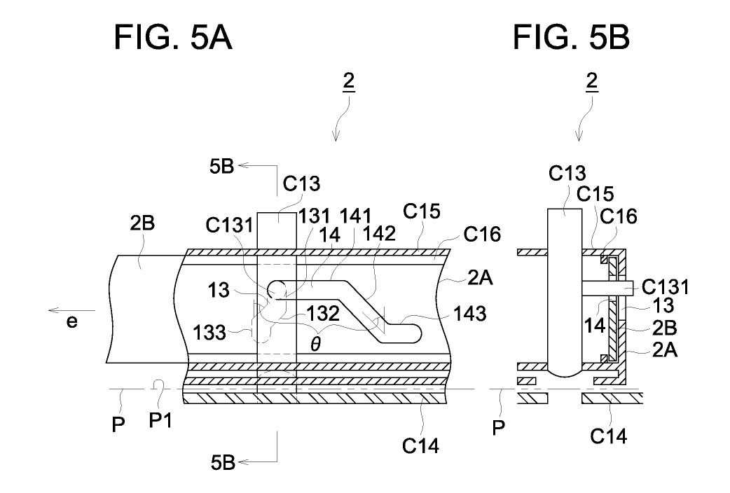

FIG. 3 is an illustration of a sheet finisher having a punching device.

There will be given explanations as follows concerning structures and operations of a sheet finisher that can conduct punching processing.

On the upper step of sheet finisher C, there are arranged a plurality of sheet feeding tray 101 that supplies sheets each serving as a cover of a booklet and fixed integrated tray 102 on which sheets P supplied from image forming apparatus B are stacked.

On the medium step, there are arranged punching device C1 that bores a punched hole on sheet P, shift section C5 that shifts sheet P in its lateral direction and movable stacking tray 103 on which the sheets having punched holes and stapled sheets are ejected or stacked.

And on the lower step, there are arranged stapling section C2 that staples a bundle of sheets P with a staple, folding section C3 that folds sheet P or a sheet bundle and stacker C4 on which sheets are stacked temporarily, to be the same inclined surface.

Further, there is arranged fixed sheet ejection tray 104 on which the sheet bundles each being folded to be of three-fold or two-fold are arranged.

Operations of the sheet finisher C will be explained as follows.

Sheet P ejected from the image forming apparatus B is fed into inlet 100.

When punching is established on operation panel SP of the image forming apparatus B (information of existence of punching), a punched hole is bored by the punching device C1, while, when the punching is not established, the punching device C1 is passed.

The punching device C1 has punch waste receiver C112 that houses punch waste produced from punching conducted by punching device main body C11 described later and by punching device main body C11 which bore a punched hole on sheet P.

Incidentally, the punching device main body C11 will be explained in detail later.

When only stacking processing is established simply, sheet P is fed into conveyance path a by switching gate G1 to be stacked on fixed stacking tray 102.

When shift processing is established, sheet P is fed into conveyance path “by” switching gate G1, and is shifted laterally for each job by shifting section C5 to be stacked on stacking tray 103 by sheet ejection roller 105.

The movable stacking tray 103 is adjusted by moving device 106 in terms of positions in the vertical direction so that the uppermost surface of the stacked sheets may come to the position that is suitable for sheet ejection position of sheet ejection roller 105.

When staple processing is established, sheet P is fed into conveyance path “c” by switching gate G1, then, prescribed number of sheets are stacked by stacker C4, and a stable is driven in at stapling section C2 and sheets are bound to be in a booklet style.

Then, by causing movable stopper C45 to go up, a booklet is raised along inclined stacking surface C41 so that sheets are stacked on movable stacking tray 103 by sheet ejection roller 105.

Further, when folding processing is established, prescribed number of sheets are stacked at stacker C4 in the same way, and after that, a bundle of sheets is folded by folding section C3, to be stacked on fixed sheet ejection tray 104 after folding.

Incidentally, in stacker C4, sheets P fed out from conveyance rollers C42, C43 and C44 are ejected to the space on the upper part of stacker C4. After the ejection, the sheet P starts to go down by it empty weight, and slides downward obliquely along stack surface C41, and hits stopper surface C45 to stop.

A plurality of sheets conveyed successively in the aforesaid way are stacked on stacking surface C41 of stacker C4, and they form a bundle of sheets.

Further, stapling section C2 has therein staple-driving mechanism C21, staple-receiving mechanism C22 and an unillustrated drive section that drives the staple-driving mechanism C21, and the staple-receiving mechanism C22. Then, when a prescribed number of sheets P are stacked on stacker C4, the drive section operates, and a staple is driven in at the position corresponding to the lowest position of the movable stopper C45, for example, an end portion of the sheet bundle or at the center position, thus, the stapling processing is carried out

Further, folding section C3 has therein paired folding rollers C31 that folds a bundle of sheets by pressing, thrusting-in member C32 that thrusts a spine of a bundle of sheets into a space between a pair of folding rollers C31, and an unillustrated moving section that moves the thrusting-in member C32 toward the folding rollers C31.

Then, when the center portion of the stacked bundle of sheets is thrust in a space between folding rollers C31, the center portion of the stacked bundle of sheets receives pressure to be bent to become a state of booklet.

Post-processing control section D2 controls the whole of sheet finisher mentioned above, and receives information relating to post-processing that is transmitted from the communication device T1 of image forming apparatus B through communication device T2.

The post-processing is carried out in the aforesaid way, and plural types of punching device main bodies are explained as follows.

Punching device main body C11 has therein a punch that bores a punched hole on a sheet, a die that engages with the punch, a support member that supports the punch so that the punch may move vertically and may rotate, a fixed cam plate that is formed to be integrated with the support member and a movable cam plate that can move in the horizontal direction.

The movable cam plate is arranged to be possible to change its position in the horizontal direction through a drive mechanism which will be described later (for example, a drive motor, a pinion and a rack gear).

On each of the fixed cam plate and the movable can plate, there is bored a hole having a cam (that is a cam hole), and on the punch, there is fixed a pin that passes through the cam hole.

When the movable cam plate moves, a pin regulated by the fixed cam plate and a pin regulated by the movable cam plate move continuously, and a hole is punched on the sheet when urging a punch against the sheet.

A combination of one punch (including a pin), a die hole corresponding to the punch, a cam hole corresponding to the aforesaid punch and is bored on fixed cam and a cam hole that is bored on the movable cam plate and corresponds to the aforesaid punch is called a punching unit.

The punching unit will be explained as follows, referring to the drawings. Incidentally, for making the drawings to be easy to see, hatching is given also to the portion that is not a cross section.

Each of FIGS. 4A-4B is an illustration for the punching unit of the First Embodiment.

FIG. 4A is a front diagram of the first punching unit, and it shows the state wherein the punch is positioned at the standby position which is not in the punching operation, while, FIG. 4B is a cross sectional view (4B-4B section) wherein the first punching unit is viewed from the side.

The first punching unit 1 has therein punch C13 that bores a punched hole on a sheet, die C14 that engages with the punch C13, support member C15 that supports the punch C13 to be movable vertically and to be rotatable, fixed cam plate (also referred to as fixed cam member) 1A that is one plate formed solidly with the support member C15 and movable cam plate (also referred to as movable cam member) 1B representing one plate that can move in the horizontal direction while being guided by guide member C16 formed on the support member C15.

The movable cam plate 1B is arranged to be movable in the horizontal direction by the driving mechanism described later (for example, drive motor, a pinion provided on the output shaft of the drive motor, a rack gear that engages with the pinion and a movable cam plate on which the rack gear is fixed).

Namely, the fixed cam plate 1A and movable cam plate 1B are capable of moving their positions in the horizontal direction.

On the fixed cam plate 1A, the first cam hole 11 is bored at the position corresponding to punch C13, and on movable cam plate 1B, there is bored the second cam hole 12, and on the punch C13, there is fixed pin C131 that passes through the first cam hole 11 and the second cam hole 12.

Due to this, pin C131 is regulated by the first cam hole 11 and the second cam hole 12, and it moves in the cam holes.

Then, on the fixed cam plate 1A, there is bored cam hole 11 having the 1^{st} vertical portion 111 extending in the direction running parallel to the axis of punch C13 and having the 1^{st} inclined portion 112 that has a prescribed angle for an axis of punch C13 and is connected to go down obliquely from the 1^{st} vertical portion 111.

Then, on the movable cam plate 1B, there is bored the second cam hole 12 that has the 2^{nd} inclined portion 121 having a prescribed angle for an axis of the punch C13 and facing to the opposite side to the 1^{st} inclined portion 112 and extending downward obliquely.

The 1^{st} inclined portion 112 and the 2^{nd} inclined portion 121 are inclined to be opposite to each other, and a center line of a cam hole has an angle θ, for example, 45° for the horizontal direction, and both inclined portions can intersect each other when the movable cam plate 1B moves.

Further, in the direction running parallel with an axis of punch C13, an end portion that is opposite to the die of the 1^{st} vertical portion 111 and an end portion opposite to the die of the 2^{nd} inclined portion 121 are on the same position, and an end portion on the side of a die of the 1^{st} inclined portion 112 and an end portion on the side of a die of the 2^{nd} inclined portion 121 are on the same position.

Operations of the first punching unit 1 will be explained as follows.

Before the punching operations, pin C131 is positioned at the uppermost section (standby position) of the first cam hole 11 and the second cam hole 12 as is illustrated. In this case, tip portion C132 of punch C13 is positioned to be higher than surface P1 of a sheet having the maximum thickness that can be punched, to make it easy for a sheet to advance to the first punching unit 1.

When movable cam plate 1B moves in the direction of arrow “e”, 2^{nd} cam hole 12 moves in the direction of arrow “e”, and pin C131 is regulated be 1^{st} vertical portion 111 and by 2^{nd} inclined portion 121 to be urged downward.

Owing to this, the pin C131 goes down and punch C13 descends.

Further, when movable cam plate 1B moves in the direction of arrow “e”, the second cam hole 12 further moves in the direction of arrow “e”, and pin C131 is regulated by the 1^{st} inclined portion 112 and by the 2^{nd} inclined portion 121, to be urged downward obliquely first.

Due to this, the pin C131 descends and rotates simultaneously round an axis of punch C13 (hereinafter, called “punch axis”), and punch C13 starts rotating while moving downward.

Incidentally, when the pin C131 starts to be regulated by the 1^{st} inclined portion 112 and by the 2^{nd} inclined portion 121, tip portion C132 of punch C13 is positioned to be away from an upper surface of die C14 by a prescribed distance, and it has not arrived at surface P1 of the sheet that has the maximum thickness and can be punched.

The tip portion C132 of the punch C13 arrives at surface P1 of the sheet having the maximum thickness capable of being punched, after pin C131 descends by a margin distance, for example, about 0.5 mm, from the moment when pin C131 entered the first inclined portion 112 from the first vertical portion 111.

When movable cam plate 1B moves further in the direction of arrow “e”, punch C13 continues its rotation to pass through sheet P while moving downward further by the regulation by the regulation caused by the 1^{st} inclined portion 112 and by the 2^{nd} inclined portion 121 of pin C131.

Then, when pin C131 arrives at the lowermost portion (bottom dead center) of the 1^{st} inclined portion 112 and the 2^{nd} inclined portion 121, the pin C131 stops, and punch C13 stops.

After punching on a sheet is completed, the pin C131 is moved to the uppermost section of the first cam hole 11 and the second cam hole 12 by adverse operations to return the movable cam plate 1B in the direction opposite to the direction of arrow “e”. Owing to this, punch C13 arrives at the standby position and stops there, and punching on a sheet by the first punching unit 1 is terminated.

As explained above, it is possible to provide a punching unit having a simple structure that can punch stably without generating a noise, by causing the most part of the inclined portion of a cam that urges a punch to contribute to sheet punching.

Each of FIGS. 5A and 5B is an illustration of a punching unit of the second embodiment.

FIG. 5A is a front view of the second punching unit, and it shows that a punch is positioned at a standby position, and FIG. 5B is a cross section in which the second punching unit is viewed from the flank (5B-5B section).

With respect to the second punching unit 2, the portion that is different from the first punching unit 1 will be explained as follows. Incidentally, with respect to the structural portions which are the same as those in the first embodiment are given the same symbols and explanation for them will be omitted.

The second punching unit 2 is formed integrally with support member C15, and it has plate-shaped fixed cam plate 2A and plate-shaped movable cam plate 2B that can move in the horizontal direction when it is guided by leading guide member C16 formed on fixed cam plate 2A.

It is possible for fixed cam plate 2A and movable cam plate 2B to change relative positions in the horizontal direction by a drive mechanism described later which moves movable cam plate 2B.

Third cam hole 13 is bored on fixed cam plate 2A, fourth cam hole 14 is bored on movable cam plate 2B, and pin C131 that passes through the third cam hole 13 and the fourth cam hole 14 is fixed on punch C13.

Due to this, pin C131 is regulated by the third cam hole 13 and by the fourth cam hole 14 to move through the inside of the third cam hole 13.

On the third cam hole 13, 2^{nd} vertical portion 131 extending in the direction running parallel with an axis of punch C13 (corresponding to the aforesaid 1^{st} vertical portion 111) is provided, the third inclined portion 132 having a prescribed angle for an axis of the punch C13 and extending downward obliquely toward the die side from the second vertical portion 131 of the 2^{nd} vertical portion 131 to be connected (corresponding to the aforesaid 1^{st} inclined portion) is provided, and the 3^{rd} vertical portion 133 that is connected toward the die side from the 3^{rd} inclined portion 132 and is extending in the direction running parallel with an axis of punch C13 is provided at the position corresponding to punch C13.

On the fourth cam hole 14, there are bored the 1^{st} horizontal portion 141 extending in the direction intersecting at right angles with an axis of punch C13, the 4^{th} inclined portion 142 having a prescribed angle with an axis of the punch C13 and facing opposite side against the 3^{rd} inclined portion 132 to be connected and extending downward obliquely (corresponding to the aforesaid 2^{nd} inclined portion 112) and the 2^{nd} horizontal portion 143 extending in the direction intersecting at right angles with an axis of punch C13.

The 3^{rd} inclined portion 132 and the 4^{th} inclined portion 142 are inclined to be opposite each other, a center line of the cam hole makes an angle of θ, for example, 45° with the horizontal direction, and both inclined portions can intersect when movable cam 1B moves.

Then, in the direction running parallel with an axis of punch C13, an end portion that is opposite to the die of the 2^{nd} vertical portion 131 and the 1^{st} horizontal portion 141 are on the same position, and an end portion of the 3^{rd} vertical portion 133 on the die side and the 2^{nd} horizontal portion 143 are on the same position.

Operations of the second punching unit will be explained as follows, referring to FIGS. 5A-5B and FIGS. 6A-6D.

In FIGS. 5A-5B, pin C131 is positioned on the uppermost section of the third cam hole 13 (opposite to die C14) as is illustrated, and is positioned on the illustrated left side of the first horizontal portion 141 of the fourth cam hole 14, namely, at the standby position, before the punching operations. In this case, tip portion C132 of tip portion of punch C13 is positioned to be higher than surface P1 of a thickness of the sheet having the maximum thickness that can be punched, to make it easy for a sheet to enter the second punching unit 2.

In addition to the first punching unit mentioned above, it is possible to cause pin C131 to be positioned at the left side in the illustration of the first horizontal portion of the fourth cam hole 14 and at the uppermost section of the third cam hole 13 (opposite side to die C14) by providing the 1^{st} horizontal portion 141 on the fourth cam hole 14, before and after punching operations.

Owing to this, it is constituted so that a position of the pin C131 is not shifted, namely, the punch does not come off from the standby position, even when a stopping position of a movable cam plate is fluctuated a little in the horizontal direction by outer disturbances.

Further, by providing the 2^{nd} horizontal portion 143 in the fourth cam hole 14 and by providing the 3^{rd} vertical portion 133 in the third cam hole 13, it is possible to cause pin C131 to be positioned inside of the 2^{nd} horizontal portion 143 and inside of the 3^{rd} vertical portion 133.

Owing to this, it is constituted so that a position of the pin C131 is not shifted, namely, the punch does not come off the lowermost position, even when a stopping position of a movable cam plate is fluctuated a little in the horizontal direction by outer disturbances.

Each of FIGS. 6A-6D is an illustration of operations for a punching unit in the second embodiment.

In each of FIGS. 6A-6D, pin C131 is hidden to be back of punch C13 to be unseen. However, the pin is shown with a solid line so that the drawing may be easy to see.

In FIG. 6A, when movable cam plate 2B moves in the direction of arrow “e”, the fourth cam hole 14 moves in the direction of arrow “e”. However, the pin C131 is regulated by the third cam hole 13 and by the fourth cam hole 14, and it neither descend nor rotate around an axis of the punch. Due to this, the punch C13 stays at the standby position.

In FIG. 6B, when movable cam plate 2B moves in the direction of arrow “e”, the fourth cam hole 14 moves in the direction of arrow “e”, and the pin C131 is regulated by 2^{nd} vertical portion 131 and by the 4^{th} inclined portion 142 to be urged downward.

Due to this, pin C131 descends and punch C13 descends.

In this case, tip portion 0132 has not arrived at the surface P1 of the sheet having the maximum thickness which can be punched.

In FIG. 6C, when movable cam plate 2B moves further in the direction of arrow “e”, the fourth cam hole 14 further moves in the direction of arrow “e”, and pin C131 is regulated by the 3rd inclined portion 142 and by the 2^{nd} inclined portion 132 to start being urged downward obliquely.

Due to this, pin C131 descends and starts rotating (in the direction of arrow) on an axis of the punch, and the punch C13 starts descending while rotating.

Incidentally, at a point of time when the pin C131 started to be regulated by the 3^{rd} inclined portion 142 and by the 2^{nd} inclined portion 132, tip portion C132 of the punch C13 is positioned to be away from the upper surface of die C14 by a prescribed distance, and it has not arrived at surface P1 of the sheet having the maximum thickness that can be punched.

After the pin C131 descends by a prescribed margin distance, for example, about 0.5 mm from the point where the pin C131 entered the 3^{rd} inclined portion 132 from the 2^{nd} vertical portion 131, tip portion C132 of punch C13 arrives at surface P1 of the sheet having the maximum thickness capable of being punched.

Then, pin C131 is regulated by the 3^{rd} inclined portion 142 and by the 2^{nd} inclined portion 132, and the pin C131 causes punch C13 to descend while causing the punch C13 so that the sheet may be punched.

In FIG. 6D, when movable cam plate 2B is moved further in the direction of arrow “e”, the fourth cam hole 14 moves further in the direction of arrow “e”, and pin C131 is regulated by the 2^{nd} horizontal portion 143 and by the 3^{rd} vertical portion 133, and it neither descent nor rotate.

Due to this, the punch C13 arrives at a bottom dead center, and stops. In this case, a tip portion of the punch has passed through sheet P and die 53.

After the punch C13 punches sheet P, operations are carried out oppositely to the aforesaid flow, and the punch C13 ascends to return to the standby position again.

As explained above, it is possible to construct a punching unit wherein a structure on the periphery of the punch is simplified in particular, and it is possible to locate a punch surely at the standby position or a position for completion of punching, and it is possible to reduce punching noise, even when a position for stopping a movable cam plate between before and after of punching operation is changed a little.

As explained above, it is possible to provide a punching unit that can punch stably and has a simple structure which is free from a noise, by causing the most part of an inclined portion of a cam that urges a punch to contribute to sheet punching.

Each of FIGS. 7A-7B is a detailed diagram concerning a punch and a cam hole.

FIG. 7A is a diagram showing relationship of a punch, a pin, a die and a sheet, and FIG. 7B is a diagram showing relationship between a pin and a fixed cam hole. Incidentally, FIG. 7A shows the state wherein pin C131 is positioned at a Z point (which will be described later) of a cam hole shown in FIG. 7B.

In FIG. 7A, tip portion C132 of punch C13 has a relief portion C133 that is dented to be in a circular arc, and because of the relief portion C133, only cutting edge C134 in the tip portion 132 hits sheet P so that urging force “f” in the direction of an arrow can be concentrated on the cutting edge 134.

Depth d1 of the relief portion C133 is established to be greater than thickness d2 of the thickest sheet to be used in the sheet finisher.

A diameter of punch C13 is, for example, 6.5 mm in Japan and Europe, and is 8.0 mm in the United States, so that the diameters may meet the standards of various countries.

Relief portion C133 makes it possible to concentrate urging force f on cutting edge C134 of the punch, and the cutting edge 134 descends gradually while it is rotating to cut sheet P slowly in a way of drawing a circle, resulting in a small urging force “f” and a small cutting noise.

In FIGS. 7A and 7B, dimensions of various portions are established so that the following expression may hold,

L11=L12=L13=L2+d2+d3

under the assumptions that L1 (L11, L12 and L13) represents a distance from a point of intersection Z between a center of a vertical portion (for example, I vertical portion 111, 2^{nd} vertical portion 131 and 4^{th} vertical portion 171) of a cam hole bored on a fixed cam plate (for example, first cam hole 11, third cam hole 13, fifth cam hole 15 and seventh cam hole 17) and a center of an inclined portion (for example, 1^{st} inclined portion 112, 3^{rd} inclined portion 132 and 5^{th} inclined portion 172) to surface C141 of die C14, L2 represents a length to cutting edge C134 of the punch, from a center of pin C131 in FIG. 7A, d2 represents a thickness of the most thick sheet, and d3 represents a margin that is a clearance between cutting edge C134 of the punch in the case of an occasion wherein pin C131 is positioned at point of intersection Z and surface P1 of the most thick sheet.

For this reason, a movable cam plate moves, and at a point in time when pin C131 arrives at the point of intersection Z after being regulated by a cam hole bored on a fixed cam plate and by a cam hole bored on a movable cam place, the cutting edge C134 is away from surface C141 of die c14 by a distance in which a thickness d2 of the most thick sheet and margin d3 are added.

Namely, it is possible to position cutting edge C134 of the punch at a location that is away from surface P1 of the thickest sheet by margin d3.

Due to this, at a point in time when the pin C131 starts to be regulated by the 3^{rd} inclined portion 142 and by the 2^{nd} inclined portion 132, for example, it is possible to position tip portion C132 of punch C13 to be away from the upper surface of die C14 by a prescribed distance, resulting in a case where the punch C13 can be moved from the position that is away from a surface of the most thick sheet by margin d3, and can be started to rotate.

Namely, before the pin C131 arrives at the point of intersection Z, the punch only descends, and after the pin C131 arrives at the point of intersection Z, the pin C131 is regulated by an inclined portion of a cam hole made on a fixed cam plate and by an inclined portion of a movable cam plate to descend and to rotate, and cutting edge C134 of the punch arrives at surface P1 of the most thick sheet, at the position where the pin C131 has descended in the vertical direction from the point of intersection Z by margin d3.

Therefore, at a point in time when pin C131 arrives at Z point, punch C13 does not punch sheet P, and it descends in the vertical direction by margin d3, and starts punching the sheet having the margin thickness. Incidentally, for the sheets which are thinner than d2 that is a thickness of the sheet having the most thick sheet, it is possible to start sheet punching after descending more by an amount equivalent to a difference of a thickness.

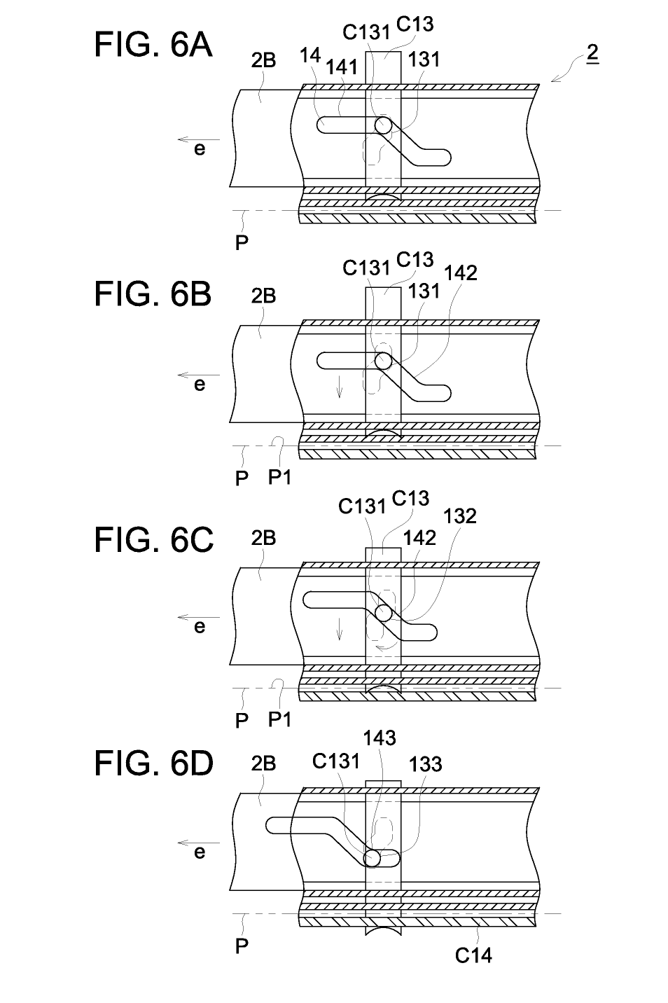

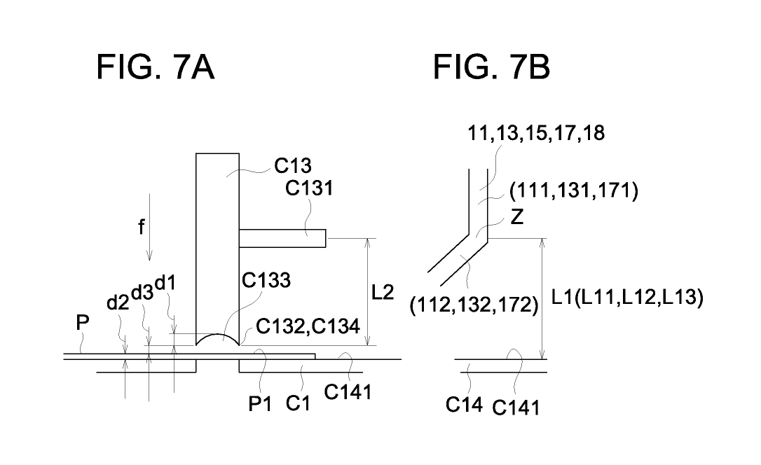

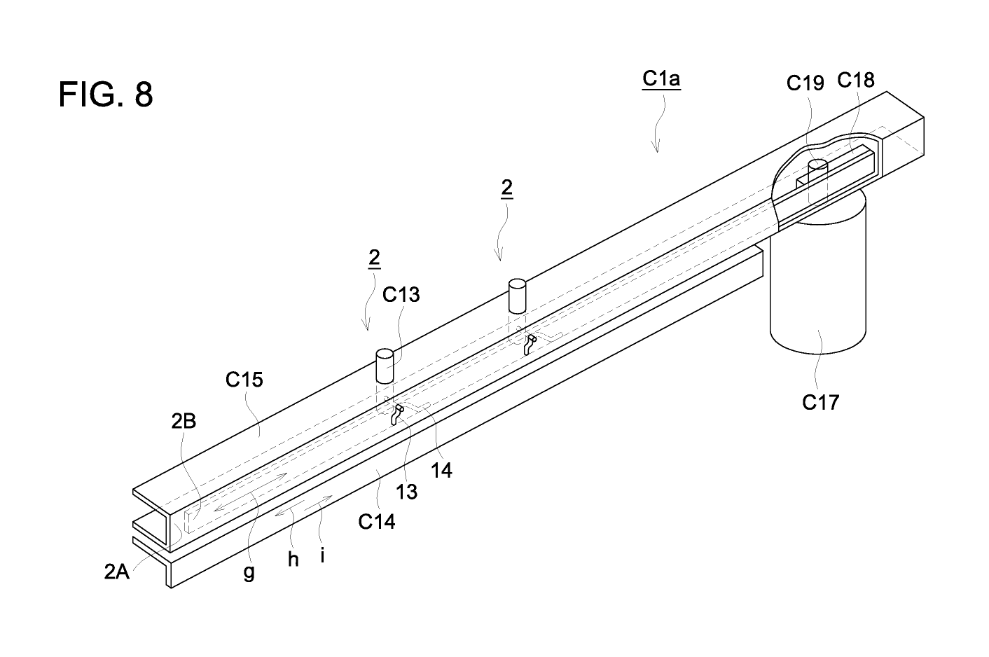

FIG. 8 is an illustration of a punching device that punches two punched holes.

Punching device C1a that punches two punched holes among punching devices C1 to be housed in sheet finisher C will be explained.

Punching device C1a that punches two punched holes is equipped with any one of the first punching unit 1 mentioned above and the second punching unit 2. In the following explanation, a punching device equipped with the aforesaid second punching unit 2 will be explained as an example. Incidentally, the detailed explanation for the second punching unit 2 will be omitted.

An illustration about the second punching unit 2 of FIGS. 5A-5B and 6A-6D and an illustration about the second punching unit 2 of FIG. 8 are opposite each other on right and left, but both of them are those doing the same operations and punching on a sheet.

Punching device C1a has therein two punches C13, one fixed cam plate 2A that supports two punches C13 and one movable cam plate 2B.

Support member C15 has punches C13 respectively at positions meeting two-hole standard (838) that is the ISO standard (punch center distance of 80 mm), and at the corresponding positions of dies C14, there are formed holes which engage with punches C13. And, a part of the support member C15 forms fixed cam plate 2A on which two third cam holes 13 are bored.

Further, the support member C15 supports movable cam plate 2B in the direction of arrow “g” on which two 4^{th} cam holes 14 are bored, and also supports motor C17 that moves movable cam plate 2b in the direction of arrow “g”.

On movable cam plate 2A, there are bored two 4^{th} cam holes at a prescribed interval.

Further, rack gear C18 is attached on an end portion of movable cam plate 2B, and the rack gear C18 is engaged with pinion C19 provided on an output shaft of motor C17. The movable cam plate 2B is moved in the direction of arrow “g” by rotation of motor C17.

Incidentally, motor C17, pinion C19 and rack gear C18 form a moving section that moves the movable cam plate in the direction that intersects at right angles with an axis of the punch.

In the explanation of an outline of operations, movable cam plate 2B is moved in the direction of arrow “h” by regular rotation of motor C17. And, two 4^{th} cam holes 14 are moved in the direction of arrow “h” by the movement of the movable cam plate 213 in the direction of arrow “h”.

Then, pin C131 that passes through the third cam hole 13 and the fourth cam hole 14 and is regulated by the third cam hole 13 and the fourth cam hole 14 is first lowered by the movement of the movable cam plate 2B in the direction of arrow “h”, and then, it rotates around an axis of the punch simultaneously with its descending.

Then, the punch C13 descends first, and then it punches a sheet through its descending and its rotation.

Then, after punching, a reverse rotation of the motor 17 moves the movable cam plate 28 in the direction of arrow “i” to return the punch C13 to the standby position.

The foregoing, is an explanation about punching device main body C11 equipped with the second punching unit 2, and it is naturally possible to replace the second punching unit with the first punching unit.

As stated above, in the punching device that punches two punched holes, it is possible to attain stable punching by causing the almost all inclined area of the cam that urges the punch to contribute to sheet punching, and it is possible to provide a punching device with a simple structure that generates no noise, and to provide a sheet finisher having the aforesaid punching device.

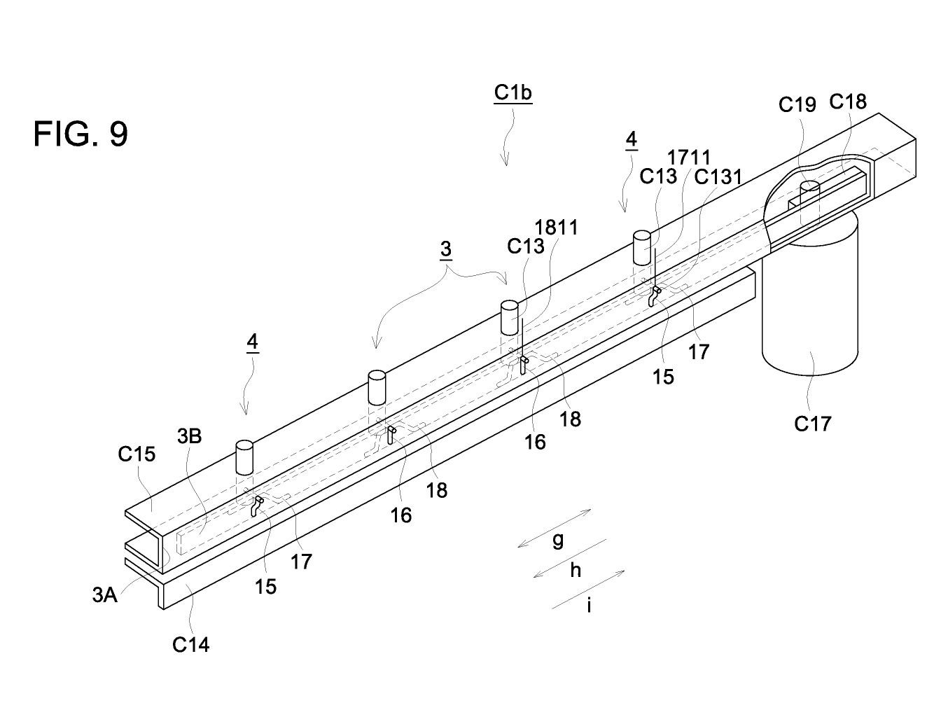

FIG. 9 is an illustration of a punching device that punches two or four punched holes.

Among punching devices C1 which are housed in the sheet finisher C, there will be given an explanation for punching device C1b that punches two holes or four holes.

The punching device C1b that punches two or four holes is equipped with four punches C13, and four cam holes are bored on one fixed cam plate and on one movable cam plate respectively.

Among four punches, two of them to be operated are attached when punching two holes from the center, and on the outer side of them, two punches to be operated when two punch holes are punched are attached.

From now on, each of two punching units at the center side is called the third punching unit, and each of two punching units on the outer side is called the fourth punching unit.

Support member C15 has punching units respectively at positions meeting four-hole standard (888) that is the ISO standard (punch center distance of 80 mm×3 positions).

And, a part of the support member C15 forms plate-shaped fixed cam plate 3A, and four cam holes are formed on the fixed cam plate 3A at the corresponding positions. At the corresponding positions on die C14, there are bored four cam holes each being engaged with punch C13.

Further, the support member C15 supports plate-shaped movable cam plate 3B on which four cam holes are formed in the direction of arrow “g”, and it supports motor C17 that moves movable cam plate 3B in the direction of arrow “g”.

And, on an end portion of movable cam plate 3B, there is attached rack gear C18 which is engaged with pinion C19 provided on output axis of motor C17. Then, the movable cam plate 2B is moved in the direction of arrow “g” by the rotation of motor C17.

The sixth cam holes 16 representing the cam holes for the third punching unit 3 are formed at two locations on the central side, and the fifth cam holes 15 representing the cam holes for the fourth punching unit 4 are formed at two locations on the both end sides.

On the movable cam plate 3B, the eighth cam holes 18 representing the cam hole for the third punching unit 3 are formed at two locations on the central side, and seventh cam holes 17 representing cam holes for the fourth punching unit 4 are formed at two locations on the both end sides, and a total length in the horizontal direction of the seventh cam hole 17 is the same as a total length of the eighth cam hole 18 in the horizontal direction.

The drawing shows the state of standby before entering punching operations.

When punching two holes, only third punching unit 3 is made to operate by moving movable cam plate 3B in the direction of arrow “i” from the illustrated state (standby position of the punch) wherein pin C131 is positioned at the central portion 1711 of the total length of the seventh cam hole 17 in the horizontal direction, and pin C131 is positioned at the central portion 1811 of the eighth cam hole 18 in the horizontal direction.

When punching 4 punched holes, central portion 1711 of the seventh cam hole 17, central portion 1811 of the eighth cam hole 18, third punching unit 3 that moves movable cam plate 3B in the direction of arrow “h” from the illustrated state where pin C131 is positioned (standby position of punch) and the fourth punching unit, are caused to operate.

Incidentally, as another embodiment to punch only 4 punched holes, it is naturally possible to move movable cam plate 3B to make punches at four places to operate by causing the cam holes corresponding to the punching units at four places to be of the same structure as the aforesaid fourth cam hole 14.

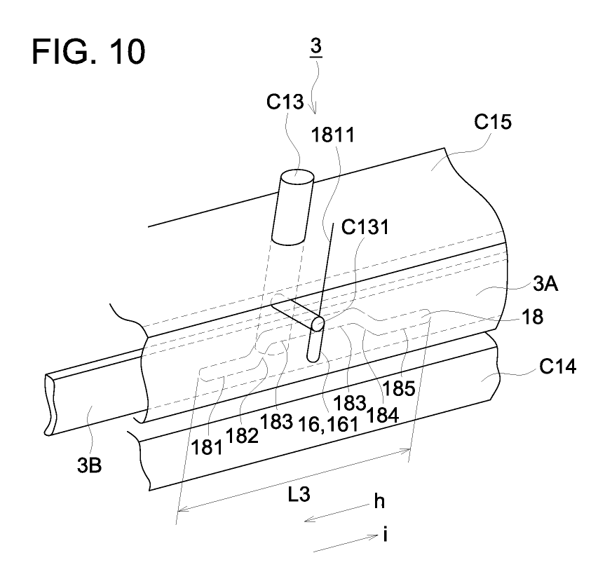

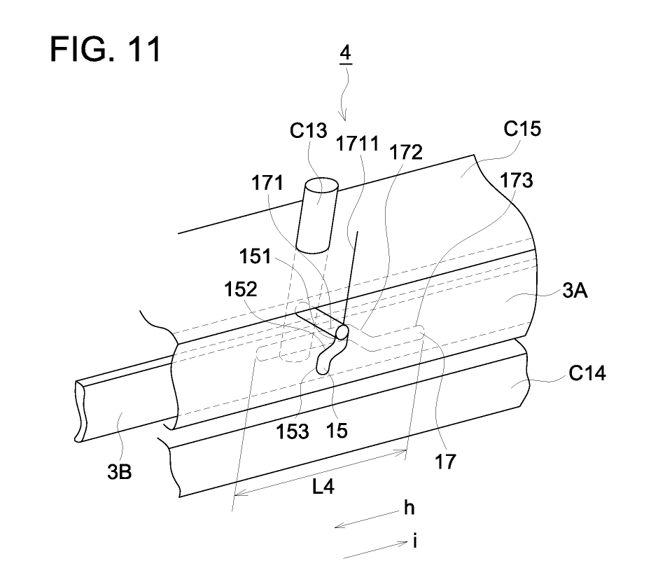

FIG. 10 is a diagram of the cam hole relating to the third punching unit 3, and FIG. 11 is a diagram of the cam hole relating to the fourth punching unit.

The structures of the cam hole relating to the third punching unit 3 and of the cam hole relating to the fourth punching unit 4 will be explained as follows, referring to FIGS. 9, 10 and 11.

The fifth cam holes having the 4^{th} vertical portion 151 extending in the direction running parallel with an axis of punch C13 (corresponding to the 1^{st} vertical portion 111), the 5^{th} inclined portion 152 having prescribed angle θ with an axis of punch C13 extending downward obliquely to be connected to 4^{th} vertical portion 151 (corresponding to the 2^{nd} inclined portion 112) and 5^{th} vertical portion 153 extending in the direction running parallel with an axis of a punch to be connected to 5^{th} inclined portion 152 on the die side are formed respectively at positions corresponding to two punches C13 which are positioned to be outside among 4 punches C13 at both end portions (FIG. 11) on fixed cam plate 3A.

Then, at the central side (FIG. 10), there are formed sixth cam holes 16 having 6^{th} vertical portions 161 extending in the direction running parallel with an axis of punch C13, at positions corresponding to two punches C13 located at the central side among 4 punches C13.

On both end sides (FIG. 11) of movable cam plate 3B, there are formed seventh cam holes 17 at two locations at a prescribed interval, and each seventh cam hole 17 has 3^{rd} horizontal portion 171 extending in the direction intersecting at right angles with an axis of punch C13, 6^{th} inclined portion 172 facing opposite side of 5^{th} inclined portion 152 to have prescribed angle θ with an axis of punch C13 to be connected to the die side from the 3^{rd} horizontal portion 171 (corresponding to the 2^{nd} inclined portion 121) and 4^{th} horizontal portion 173 extending in the direction intersecting at right angles with an axis of punch C13 to be connected with 6^{th} inclined portion 172 (opposite side to 3^{rd} horizontal portion 181).

And on the central side (FIG. 10), there are formed at two-locations at prescribed intervals eighth cam holes 18 each having 5^{th} horizontal portion 181 expending in the direction intersecting at right angles with an axis of punch C13, 7^{th} inclined portion 182 that has prescribed angle θ with an axis of punch C13 to be connected with 5^{th} horizontal portion 181 to face an opposite side and faces opposite side of 6^{th} inclined portion 172 (corresponding to 2^{nd} inclined portion 121), 6^{th} horizontal portion 183 extending in the direction intersecting at right angles with an axis of punch C13 to be connected to the opposite side of 7^{th} inclined portion 182 (opposite side to 5^{th} horizontal portion), 8^{th} inclined portion 182 that has prescribed angle θ with an axis of punch C13 to be connected toward the die side from 6^{th} horizontal portion 183, and faces the opposite side of 7^{th} inclined portion 182 (corresponding to 2^{nd} inclined portion 121), and 7^{th} horizontal portion 185 extending in the direction intersecting at right angles with an axis of the aforesaid punch to be connected to the die side of 8^{th} inclined portion 182 (opposite side to 5^{th} horizontal portion 181).

The eighth cam hole 18 is in a form of bilateral symmetry for the central section 1811 having total length of L3 in the horizontal direction of the eighth cam hole 18, and the 6^{th} horizontal portion 183 is extending to the left and to the right for the central section 1811. And, a distance from the central section 1811 of the 6^{th} horizontal portion 183 to the illustrated end portion on the left side is equal to the distance from the central section 1811 to the illustrated end portion on the right side.

Each of two punches C13 positioned at both end portions among four punches C13 has pin C131 that passes through fifth cam hole 15 and seventh cam hole 17, and each of two punches C13 positioned at the central side has pin C131 that passes through sixth cam hole 16 and eighth cam hole 18.

In the direction running parallel with an axis of punch C13, an end portion on the opposite side of a die of 6^{th} vertical portion 161 and 6^{th} horizontal portion 183 are in the same position. And an end portion on the side of the die of e vertical portion 161, 5^{th} horizontal portion 181, and 7^{th} horizontal portion 185 are in the same position.

Further, in the direction running parallel with an axis of punch C13, an end portion on the opposite side of a die of 4^{th} vertical portion 151 and 3^{rd} horizontal portion 171 are in the same position. And an end portion on the side of the die of the 5^{th} vertical portion 153 and the 4^{th} horizontal portion 173 are in the same position.

Before entering the punching operation, four pins C131 are stopped by movable cam plate 3B at the position (the standby position of the punch) to come to the central portion 1811 of the total length L3 in the horizontal direction of eighth cam holes 18 at two locations, and after completion of punching operation after sheet punching, four pins C131 are stopped by movable cam plate 3B at the position (the standby position of the punch) to come to the central portion 1711 of the total length L4 in the horizontal direction of seventh cam holes 17 at two locations.

Incidentally, total length L3 of eighth cam hole 18 in the horizontal direction is the same as total length L4 of seventh cam hole 17 in the horizontal direction.

By providing the 3^{rd} horizontal portion 171 in the seventh cam hole 17 and by providing 6^{th} horizontal portion 183 in eighth cam hole 18, it becomes possible to position pin C131 at the center of illustration for the 3^{rd} horizontal portion 171 and 6^{th} horizontal portion 183 (1711 and 1811) before punching operations, and to position pin C131 at the uppermost section of the fifth cam hole 15 and the sixth cam hole 16 (opposite side of die C14), and a position of pin C131 is not shifted, namely, punching is not shifted from the position of standby, even when the position of stopping for the movable cam plate 2B is fluctuated more or less by outer disturbance, or even when the position of stopping for the movable cam plate 2B is moved more or less.

Further, by providing 5^{th} horizontal portion 181 and 7^{th} horizontal portion 185 in eighth cam hole 18 and by providing 6^{th} vertical portion 161 in sixth cam hole 16, it becomes possible to position pin C131 inside 5^{th} horizontal portion 181 or 7^{th} horizontal portion 185, and inside 6^{th} vertical portion 161, in the case of completion of punching operations, namely, in the case of completion of movement of movable cam plate 2B.

Further, by providing 4^{th} horizontal portion 173 on seventh cam hole 17 and by providing 5^{th} vertical portion 153 on fifth cam hole 15, it is possible to position pin C131 inside the 4^{th} horizontal portion 173 and inside 5^{th} vertical portion 153, in the case of completion of punching operations, namely, in the case of completion of the movement of movable cam plate 2B.

Owing to the foregoing, a position of pin C131 is not shifted, namely, a punch is not shifted from the position where the punch completed its punching, even when the position of stopping for movable cam plate 2B is fluctuated more or less, or even when the position of stopping is moved.

Operations of the punching unit C3 will be explained as follows, referring to FIGS. 9, 10 and 11.

While two pins C131 positioned at both end portions are regulated by the 4^{th} vertical portion 151 of the fifth cam hole 15 and by 6^{th} inclined portion 172 of seventh cam hole 17 through the movement of movable cam plate 3B, two pins C131 positioned at both ends move toward die sides. Then, while two pins C131 positioned at the central side are regulated by 6^{th} vertical portion 161 of sixth cam hole 16 and by 7^{th} inclined portion 182 or by 8^{th} inclined portion 184, two pins C131 positioned at the central side move toward die side, and these move four punches C13 toward the die side.

While two pins C131 positioned at both ends are regulated 5^{th} inclined portion 152 of fifth cam hole 15 and by 6^{th} inclined portion 172 of seventh cam hole 17, two pins C131 positioned at both ends move toward die C14 while rotating with movement of movable cam plate 3B. And, as long as two pins C131 positioned at central side is regulated by 6^{th} vertical portion 161 of sixth cam hole 16 and by 8^{th} inclined portion 184 of 7^{th} inclined portion 182 of eighth cam hole 18 or by 8^{th} inclined portion 184, two pins C131 positioned at a central side move toward die C14.

Owing to the foregoing, punches C13 at both ends among four punches C13 move toward die sides while rotating, and punches C13 on the central side move toward the die side.

An occasion for punching for two punched holes at an inner side will be explained.

In FIG. 9, before entering punching operations, movable cam plate 3B is in a stop position where each pin C131 seems to come to central portion 1711 of seventh cam hole 17 and to central portion 1811 of eighth cam hole 18 as is illustrated, and each punch C13 is stopped at its standby position.

Post-processing control section D2 is means of communication T2, and when it receives information of two punched holes established on operation panel SP of image forming apparatus B, it causes motor C17 to rotate reversely to move movable cam plate 3B in the direction of arrow “i” through pinion C19 and rack gear C18.

Due to a movement of movable cam plate 3B in the direction of arrow “i”, each cam hole bored on the movable cam plate 3B also moves in the direction of arrow “i”.

In the explanation above third punching unit 3, when movable cam plate 3B moves in the direction of arrow “i”, two pins C131 on the central side move through 6^{th} horizontal portion 183 of eighth cam hole 18 (on the side of direction of arrow “h”), 7^{th} inclined portion 182 and 5^{th} horizontal portion 181 in succession, in the state wherein each is regulated by 6^{th} vertical portion 161 of sixth cam hole 16.

Therefore, punch C13 descends, and it punches sheets while descending.

After punching the sheets, post-processing control section D2 causes motor C17 to rotate regularly to move movable cam plate 3B in the direction of arrow “h”, through pinion C19 and rack gear C18. Then, each pin C131 is moved to the position where pin C131 seems to come to central portion 1711 of seventh cam hole 17 and to come to central portion 1811 of eighth cam hole 18 as illustrated, and after that, each punch C13 is returned to standby position to be stopped.

In the explanation about fourth punching unit 4, when movable cam plate 3B is moved in the direction of arrow “i”, pin C131 moves through 3^{rd} horizontal portion 171 of seventh cam hole 17 relatively (on the side of direction of arrow “h”) under the state of regulation by the 4^{th} vertical portion 151 of fifth cam hole 15, thus, the pin C131 does not descend.

Therefore, the punch C13 is stopped at the standby position.

As explained above, third punching unit 3 only, namely, two punches on the center side only are caused to operate so that the two punched holes can be punched.

Next, an occasion to punch four punched holes will be explained.

In FIG. 9, before entering punching operations, movable cam plate 3B is stopped at a position wherein each pin C131 may come to center portion 1711 of seventh cam hole 17 and to center portion 1811 of eighth cam hole 18 as is illustrated, and each punch C13 is stopped at standby position.

When post-processing controlling section D2 receives information of 4 punched holes D2 established by operation panel SP of image forming apparatus B by communication device T2, the post-processing controlling section D2 causes motor C17 to rotate regularly to move movable cam plate 3B in the direction of arrow “h” through pinion C19 and rack gear C18.

Respective cam holes bored on the movable cam plate 3B are also moved in the direction of arrow “h” by the movement of the movable cam plate 3B in the direction of arrow “h”.

In the explanation about 4^{th} punching unit 4 arranged on both end sides, when the movable cam plate 3B moves in the direction of arrow “h”, pin C131 moves through 3^{rd} horizontal portion 171 of seventh cam hole 17, 6^{th} inclined portion 172, 4^{th} horizontal portion 173 in succession relatively, while being regulated successively by 4^{th} vertical portion 151 of fifth cam hole 15, 5^{th} inclined portion 152 and by 5^{th} vertical portion 153.

Therefore, the punch C13 descends and then, it rotates while descending. Thus, the punch C13 punches sheets while rotating and descending.

In the explanation about third punching unit 3 arranged on the center side, when the movable cam plate 3B moves in the direction of arrow “h”, pin C131 moves through 6^{th} horizontal portion 183 of eighth cam hole 18 (on the side of direction of arrow “i”), 8^{th} inclined portion 184 and 7^{th} horizontal portion 185 in succession relatively, under the state of being regulated by 6^{th} vertical portion 161 of sixth cam hole 16.

Therefore, the punch C13 punches sheets while descending.

After the sheet punching, the post-processing controlling section D2 causes motor C17 to rotate reversely to move movable cam plate 3B in the direction of arrow “i” through pinion C19 and rack gear C18. And each pin C131 is moved to the position wherein the each pin C131 may come to center portion 1711 of seventh cam hole 17 and to center portion 1811 of eighth cam hole 18 as is illustrated, and each pin C131 is stopped. Owing to this, each punch C13 returns to its standby position and stops.

Thus, third punching unit 3 and fourth punching unit 4 are operated to be capable of punching 4 punched holes.

As stated above, in the punching device that punches two or four punched holes, it is possible to attain stable punching by causing the almost all inclined area of the cam that urges the punch to contribute to sheet punching, and it is possible to provide a punching device with a simple structure that generates no noise, and to provide a sheet finisher having the aforesaid punching device.

Further, it is also possible to provide a punching device wherein a punching process for two punched holes and a punching process for four punched holes can be switched easily only by changing a movement direction of a movable cam plate by a controller, and to provide a sheet finisher furnished with the aforesaid punching device.

The aforesaid embodiments make it possible to punch holes stably by causing the almost all inclined area of the cam that urges the punch to contribute to sheet punching and to provide a punching device having a simple structure that makes no noise, a sheet finisher having the punching device and an image forming system having the aforesaid sheet finisher.

What is claimed is:

1. A punching device comprising:
(a) a plurality of punches each of which is arranged to be spaced apart from each other by a predetermined distance;
(b) a die including a plurality of punching holes with each of which each of the plurality of punches is engaged;
(c) a support member which supports rotatably each of the punches and movably in a direction of each rotation axis thereof;
(d) a fixed cam member provided on the support member, on which a first cam hole is formed in a position corresponding to each of the punches, the first cam hole having at least a first vertical portion that extends in a direction parallel to each rotation axis of the punches and a first inclined portion that connects with the first vertical portion at a predetermined angle to each rotation axis of the punches and extends toward the die; and
(e) a movable cam member provided on the fixed cam member, capable of moving along the support member in a direction perpendicular to each rotation axis of the punches, on which a second cam hole is formed in the position corresponding to each of the punches to be spaced apart from each other by the predetermined distance, the second cam hole having at least a second inclined portion which has a predetermined angle to each rotation axis of the punches and turns toward a side opposite to the first inclined portion;
wherein each of the plurality of punches has a pin passing through each of the first and second cam holes, and
wherein when the pin is regulated by the first vertical portion and the second inclined portion, each of the punches moves toward the die by movement of the movable cam member, and when the pin is regulated by the first inclined portion and the second inclined portion, each of the punches moves toward the die by the movement of the movable cam member and rotates about each rotation axis of the punches.

2. The punching device of claim 1, wherein an end portion of the first vertical portion and an end portion of the second inclined portion on an opposite side of the die in a direction parallel to each rotation axis of the punches, have a same position as each other, and an end portion of the first inclined portion and an end portion of the second inclined portion on a side of the die in the direction parallel to each rotation axis of the punches, have a same position as each other.

3. The punching device of claim 1, wherein the following expression is satisfied,
L11=L2+d2+d3
where L11 represents a distance in the direction in parallel to each axis of the punches between a point at an intersection of a center line of the first vertical portion with a center line of the first inclined portion, and an upper surface of the die with which the punch is engaged; L2 represents a distance between a center of an axis of each of the pins and a cutting edge of each of the punches; d2 represents a maximum thickness of a sheet to be used; and d3 represents room which is a gap between the cutting edge of each of the punches and an upper surface of the sheet having the maximum thickness, when the center of the axis of the pin is positioned at the point at the intersection.

4. A punching device comprising:
(a) a plurality of punches each of which is arranged to be spaced apart from each other by a predetermined distance;
(b) a die including a plurality of punching holes with each of which each of the plurality of punches is engaged;
(c) a support member which supports rotatably each of the punches and movably in a direction of each rotation axis thereof;
(d) a fixed cam member provided on the support member, on which a first cam hole is formed in a position corresponding to each of the punches, the first cam hole having a first vertical portion that extends in a direction parallel to each rotation axis of the punches, a first inclined portion that connects with the first vertical portion at a predetermined angle to each rotation axis of the punches and extends toward the die, and a second vertical portion that connects with the first inclined portion and extends in the direction parallel to each rotation axis of the punches toward the die; and
(e) a movable cam member provided on the fixed cam member, capable of being moved along the support member in a direction perpendicular to each rotation axis of the punches, on which a second cam hole is formed in the position corresponding to each of the punches to be spaced apart from each other by a predetermined distance, the second cam hole having a first horizontal portion that extends in the direction perpendicular to each rotation axis, a second inclined portion having a predetermined angle to each rotation axis of the punches that connects with the first horizontal portion, extends toward the die, and turns toward a side opposite to the first inclined portion, and a second horizontal portion that connects with the second inclined portion and extends in the direction perpendicular to each rotation axis of the punches;
wherein each of the plurality of punches has a pin passing through each of the first and second cam holes, and
wherein when the pin is regulated by the first horizontal portion and the first vertical portion, or is regulated by the second horizontal portion and the second vertical portion, each of the punches stops, when the pin is regulated by the first vertical portion and the second inclined portion, the punch moves toward the die by movement of the movable cam member, and when the pin is regulated by the first inclined portion and the second inclined portion, the punch moves toward the die by the movement of the movable cam member and rotates about each rotation axis of the punches.

5. The punching device of claim 4, wherein an end portion of the first vertical portion and an end portion of the first horizontal portion on an opposite side of the die in a direction parallel to each axis of the punches, have the same position as each other, and an end portion of the second vertical portion and an end portion of the second horizontal portion on a side of the die in the direction parallel to each axis of the punches, are in a same position as each other.

6. The punching device of claim 4, wherein the following expression is satisfied,
L12=L2+d2+d3
where L12 represents a distance in a direction in parallel to each axis of the punches between a point at an intersection of a center line of the first vertical portion with a center line of the first inclined portion, and an upper surface of the die with which the punch is engaged; L2 represents a distance between a center of an axis of each of the pins and a cutting edge of each of punches; d2 represents a maximum thickness of a sheet to be used; and d3 represents room which is a gap between the cutting edge of the punch and an upper surface of the sheet having the maximum thickness, when the center of the axis of the pin is positioned at the point at the intersection.

7. A punching device comprising:
(a) four punches;
(b) a die including four punching holes with each of which each of the four punches is engaged;
(c) a support member which supports rotatably each of the punches and movably in a direction of each rotation axis direction thereof to be spaced apart from each other by a predetermined distance;
(d) a fixed cam member at which the support member is provided, on which a first cam hole is formed at both end portions thereof at a position corresponding to each of two outermost punches of the four punches, the first cam hole having a first vertical portion that extends in a direction parallel to each rotation axis of the punches and a first inclined portion that connects with the first vertical portion at a predetermined angle to each rotation axis of the punches and extends toward the die, and a second vertical portion that connects with the first inclined portion and extends in a direction parallel to each rotation axis of the punches toward the die, and on which a second cam hole is formed at a central portion thereof at a position corresponding to each of two innermost punches of the four punches, having a third vertical portion that extends in a direction parallel to each rotation axis of the punches; and
(e) a movable cam member provided on the fixed cam member, capable of moving along the support member in a direction perpendicular to each rotation axis, on which a third cam hole is formed at both end portions thereof at a position corresponding to each of two outermost punches of the four punches to be spaced apart from each other by a predetermined distance, the third cam hole having a first horizontal portion that extends in a direction perpendicular to each rotation axis of the punches, a second inclined portion that connects with the first horizontal portion at a predetermined angle to each rotation axis of the punches and turns toward a side opposite to the first inclined portion, and a second horizontal portion that connects with the second inclined portion and extends in a direction perpendicular to each rotation axis of the punches toward the die, and on which a fourth cam hole is formed at a central portion thereof at a position corresponding to each of two innermost punches of the four punches to be spaced apart from each other by a predetermined distance, the fourth cam hole having a third horizontal portion that extends in the direction perpendicular to each rotation axis of the punches, a third inclined portion that connects with the third horizontal portion at a predetermined angle to each rotation axis of the punches and turns toward a side opposite to the second inclined portion, a fourth horizontal portion that connects with the third inclined portion and extends in the direction perpendicular to each rotation axis of the punches, a fourth inclined portion that connects with the fourth horizontal portion at a predetermined angle to each rotation axis of the punches and turns toward a side opposite to the third inclined portion, and a fifth horizontal portion that connects with the fourth inclined portion on the side of the die and extends in the direction perpendicular to each rotation axis of the punches,
wherein each of the two outermost punches of the four punches has a pin which passes through the first and third cam holes, and each of the two innermost punches has a pin which passes through the second and fourth holes,
wherein when each of the two innermost pins is regulated by one of the fourth horizontal portion, the third horizontal portion or the fifth horizontal portion, and by the third vertical portion, each of the two innermost pins stops, thereby each of the two innermost punches stops,
wherein when each of the two outermost pins is regulated by first horizontal portion and the first vertical portion, or by the second horizontal portion and the second vertical portion, each of the two innermost pins stops, thereby each of the two innermost punches stops,
wherein when each of the two innermost pins is regulated by one of the third or fourth inclined portion and the third vertical portion, each of the two innermost punches moves toward the die by movement of the movable cam member,
wherein each of the two outermost pins is regulated by the first vertical portion and the second inclined portion, each of the two outermost punches moves toward the die by the movement of the movable cam member, and
wherein each of the outermost pins is regulated by the first and the second inclined portions, each of the two outermost punches moves toward the die while being rotated by the movement of the movable cam member.

8. The punching device of claim 7, wherein an end portion of the third vertical portion and an end portion of the first vertical portion on an opposite side of the die in the direction parallel to each axis of the punches, the fourth horizontal portion and the first horizontal portion, have a same position as each other, and an end portion of the third vertical portion on the side of the die and an end portion of each of the third, fifth and second horizontal portions in the direction parallel to each axis of the punches, have a same position as each other.

9. The punching device of claim 7, wherein an entire length in a horizontal direction of the third cam hole is equal to that of an entire length in the horizontal direction of the fourth cam hole.

10. The punching device of claim 7,
wherein when two holes are punched, the movable member moves toward one direction from a standby state at which each of the two innermost pins is positioned in a central portion of the entire length of the third cam hole in the horizontal direction, and each of the two outermost pins is positioned in a central portion of the entire length of the fourth cam hole in the horizontal direction, thereby the two innermost punches only are operated, and
wherein when four holes are punched, the movable member moves toward another direction from a standby state at which each of the two innermost pins is positioned in the central portion of the entire length of the third cam hole in the horizontal direction, and each of the two outermost pins is positioned in the central portion of the entire length of the fourth cam hole in the horizontal direction, thereby the two innermost punches and the two outermost punches are operated.

11. The punching device of claim 7, wherein the following expression is satisfied,
L13=L2+d2+d3
where L13 represents a distance in a direction in parallel to each axis of the punches between a point at an intersection of a center line of the first vertical portion with a center line of the first inclined portion, and an upper surface of the die with which the punch is engaged; L2 represents a distance between a center of an axis of each of the pins of the two outermost punches and a cutting edge of each of the two outermost punches; d2 represents a maximum thickness of a sheet to be used; and d3 represents room which is a gap between the cutting edge of the punch and an upper surface of a sheet having the maximum thickness, when the center of the axis of each of the pins of the punches is positioned at the point at the intersection.

12. The punching device of claim 1, further comprising a moving section which is capable of moving the movable cam member in the direction perpendicular to each axis of the punches.

13. The punching device of claim 1, wherein a cutting end of each of the punches has a recess, and a protruded portion of the cutting end forms the cutting edge.

14. The punching device of claim 1, wherein the movable cam member has a tabular form.

15. A sheet finisher comprising the punching device of claim 1.

16. An image forming system comprising:
an image forming apparatus that forms an image on a recording sheet; and
the sheet finisher of claim 15 conducts a post processing on the recording sheet that has been formed by the image forming apparatus.

17. The punching device of claim 4, further comprising a moving section which is capable of moving the movable cam member in the direction perpendicular to each axis of the punches.

18. The punching device of claim 4, wherein a cutting end of each of the punches has a recess, and a protruded portion of the cutting end forms the cutting edge.

19. The punching device of claim 4, wherein the movable cam member has a tabular form.

20. A sheet finisher comprising the punching device of claim 4.

21. An image forming system comprising:
an image forming apparatus that forms an image on a recording sheet; and
the sheet finisher of claim 20 conducts a post processing on the recording sheet that has been formed by the image forming apparatus.

22. The punching device of claim 7, further comprising a moving section which is capable of moving the movable cam member in the direction perpendicular to each axis of the punches.

23. The punching device of claim 7, wherein a cutting end of each of the punches has a recess, and a protruded portion of the cutting end forms the cutting edge.

24. The punching device of claim 7, wherein the movable can member has a tabular form.

25. A sheet finisher comprising the punching device of claim 7.

26. An image forming system comprising:
an image forming apparatus that forms an image on a recording sheet; and
the sheet finisher of claim 25 conducts a post processing on the recording sheet that has been formed by the image forming apparatus.
